(19) United States
(12) Patent Application Publication
(10) Pub. No.: US 2024/0362710 A1
(43) Pub. Date: Oct. 31, 2024

(54) METHOD AND SYSTEM FOR ESTABLISHING A LINK BETWEEN COMPANY EVENT NEWS AND A TRADING EVENT ALERT IN TRADE SURVEILLANCE SYSTEM

(71) Applicant: Acitimize LTD., Ra'anana (IL)

(72) Inventors: Ankit JAIN, Pune (IN); Nikhil RUDRAKAR, Pune (IN); Rakesh BHOSALE, Pune (IN)

(21) Appl. No.: 18/139,966

(22) Filed: Apr. 27, 2023

(51) Int. Cl. G06Q 40/04; G06F 16/95; G06F 18/23213

(52) U.S. Cl. CPC G06Q 40/04; G06F 16/95; G06F 18/23213

(57) ABSTRACT

A computerized-method for reducing false-positive transaction-alerts in a trade-surveillance system. The computerized-method includes operating a raw-news-filtering module to select raw input stock-news to yield filtered stock-news. The raw input stock-news includes events which are related to stock market and each event in the events has associated news-metadata. Operating an alert-discovery module to evaluate transaction-alerts, based on the filtered stock-news, and to yield transaction-alert related data points. Operating K-means-clustering module to collect the transaction-alert related data points and form clusters of the transaction-alert related data points, where each cluster is associated with a category. Operating a prioritization module to assign a priority to each transaction-alert related data point of the transaction-alert related data points based on the associated category of the cluster of the transaction-alert related data point and a transaction-related risk and forwarding each transaction-alert related data point that is assigned a priority above a preconfigured threshold to a compliance-officer.

### TECHNICAL FIELD

The present disclosure relates to the field of data analysis and more specifically to a method for reducing false-positive transaction-alerts in a trade-surveillance system.

### BACKGROUND

Current trade surveillance systems and alerts have traditionally been focused on trading patterns alone. However, often times it is important to understand when news about company events has been announced and information has become public knowledge in order to assess whether a trading event happened before or was influenced by such news. Until now, the correlation between news and trading events has not found its way into the trade surveillance process in a way that enables compliance to reference news data as input and display the impact it has had on transaction-alerts which have been generated or reviewed. Utilizing news-based data as an input to correlate alerts can add value by prioritizing issues related to current events and uncovering faster market abuse or insider dealing-related issues that the firm may be subject to. Accordingly, there is a need for a technical solution to use news as a means to filter alerts based on a specific news event as the starting point for a compliance review process. There is a need for system and method for reducing false-positive transaction-alerts in a trade-surveillance system.

### SUMMARY

There is thus provided, in accordance with some embodiments of the present disclosure, a computerized-method for reducing false-positive transaction-alerts in a trade-surveillance system.

In accordance with some embodiments of the present disclosure, the computerized-method includes operating a raw-news-filtering module to select raw input stock-news which are received from a platform of a source based on preconfigured one or more criteria to yield filtered stock-news. The raw input stock-news comprising one or more events which are related to stock market and each event in the one or more events has associated news-metadata.

Furthermore, in accordance with some embodiments of the present disclosure, operating an alert-discovery module to evaluate transaction-alerts received in a preconfigured date-range. The evaluation may be based on the filtered stock-news, and the evaluation may yield one or more transaction-alert related data points.

Furthermore, in accordance with some embodiments of the present disclosure, operating K-means-clustering module to collect the transaction-alert related data points and form one or more clusters of the transaction-alert related data points, each cluster of the one or more clusters is associated with a category.

Furthermore, in accordance with some embodiments of the present disclosure, operating a prioritization module to assign a priority to each transaction-alert related data point of the transaction-alert related data points, based on the associated category of the cluster of the transaction-alert related data point and a transaction-related risk.

Furthermore, in accordance with some embodiments of the present disclosure, forwarding each transaction-alert related data point that is assigned a priority above a preconfigured threshold-to a compliance officer

Furthermore, in accordance with some embodiments of the present disclosure, the one or more criteria may be selected from at least one of: (i) symbol; (ii) market; (iii) source; (iv) relevance-score; and (v) novelty.

Furthermore, in accordance with some embodiments of the present disclosure, the platform of source may be a platform of a news provider.

Furthermore, in accordance with some embodiments of the present disclosure, the news-metadata includes at least one of: (i) stock symbol; (ii) Market Identifier Code (MIC); (iii) company information.

Furthermore, in accordance with some embodiments of the present disclosure, the K-means-clustering module may be operated by using a regular expressions language to match transaction-alerts and news-metadata of the one or more events to assign transaction-alert data points to a cluster.

Furthermore, in accordance with some embodiments of the present disclosure, the assigning of each transaction-alert data point to a cluster is by finding centroid assignment.

Furthermore, in accordance with some embodiments of the present disclosure, the finding of the centroid assignment is by calculating Euclidean distance. The Euclidean distance may be calculated by formula I:

$$d ( p , q ) = \sqrt{{\sum }_{i = 1}^{n} {( {q}_{i} - {p}_{i} )}^{2}} \qquad ( I )$$

whereby:
p,q are two random data points in an Euclidean n-space,
q_i, p_i are Euclidean vectors, starting from an origin of the space, and
n=n-space.

Furthermore, in accordance with some embodiments of the present disclosure, the preconfigured one or more criteria may be selected in real-time.

Furthermore, in accordance with some embodiments of the present disclosure, the category may be selected from at least one of: (i) low; (ii) medium; (iii) high; and (iv) another category.

Furthermore, in accordance with some embodiments of the present disclosure, a notification may be sent as to each transaction-alert related data point that is assigned a priority above a preconfigured threshold to a compliance officer for investigation.

Furthermore, in accordance with some embodiments of the present disclosure, for each transaction-alert related data point that is assigned the priority above the preconfigured threshold, the computerized-method may further include pausing a transaction that the transaction-alert related data point that is assigned the priority above the preconfigured threshold related to.

Furthermore, in accordance with some embodiments of the present disclosure, for each transaction-alert related data point that is assigned the priority above the preconfigured threshold putting at least one of: (i) financial institution; (ii) trader; and (iii) account, that a transaction that is related to the transaction-alert related data point that is assigned the priority above the preconfigured threshold has been conducted through, under a watchlist.

Furthermore, in accordance with some embodiments of the present disclosure, each transaction-alert related data point that is assigned the priority above the preconfigured threshold is presented via a display unit with related details.

Furthermore, in accordance with some embodiments of the present disclosure, the transaction-alerts may be generated by analytics modules which comprise a set of detection algorithms.

Furthermore, in accordance with some embodiments of the present disclosure, the alert-discovery module may evaluate the transaction-alerts by operating a set of Application Programming Interfaces (API) s which fetch the transaction-alerts that have matching news metadata as in the filtered stock-news, from a database.

There is further provided, in accordance with some embodiments of the present invention, a computerized-system for reducing false-positive transaction alerts in a trade-surveillance system.

Furthermore, in accordance with some embodiments of the present disclosure, the computerized-system includes one or more processors, the one or more processors are configured to: (i) operate a raw-news-filtering module to select raw input stock-news which are received from a platform of a source based on preconfigured one or more criteria to yield filtered stock-news. The raw input stock-news comprising one or more events which are related to stock market and each event in the one or more events has associated news-metadata; (ii) operate an alert-discovery module to evaluate transaction-alerts received in a preconfigured date-range. The evaluation is based on the filtered stock-news, and the evaluation yields one or more transaction-alert related data points; (iii) operate K-means-clustering module to collect the transaction-alert related data points and form one or more clusters of the transaction-alert related data points, each cluster of the one or more clusters is associated with a category; (iv) operate a prioritization module to assign a priority to each transaction-alert related data point of the transaction-alert related data points, based on the associated category of the cluster of the transaction-alert related data point and a transaction-related risk; and (v) forward each transaction-alert related data point that is assigned a priority above a preconfigured threshold-to a compliance officer.

### BRIEF DESCRIPTION OF THE DRAWINGS

In order for the present invention, to be better understood and for its practical applications to be appreciated, the following Figures are provided and referenced hereafter. It should be noted that the Figures are given as examples only and in no way limit the scope of the invention. Like components are denoted by like reference numerals.

FIG. 1A schematically illustrates a high-level diagram of a computerized-system for reducing false-positive transaction-alerts in a trade-surveillance system, in accordance with some embodiments of the present invention;

FIG. 1B schematically illustrates a high-level work-flow on a computerized-system for reducing false-positive transaction-alerts in a trade-surveillance system, in accordance with some embodiments of the present invention;

FIGS. 2A-2B are a schematic flowchart a computerized-method for reducing false-positive transaction-alerts in a trade-surveillance system, in accordance with some embodiments of the present invention;

FIG. 3 is a schematic flowchart of a raw news filtering module, in accordance with some embodiments of the present invention;

FIG. 4 is a schematic flowchart of an alert-discovery module, in accordance with some embodiments of the present invention;

FIG. 5 is a diagram which illustrates a request for data using Application Programming Interface (API), in accordance with some embodiments of the present invention;

FIG. 6 is a schematic flowchart of a K-means-clustering module, in accordance with some embodiments of the present invention;

FIG. 7 a schematic flowchart of an example of high-priority alerts assigned to an account or to a trader, in accordance with some embodiments of the present invention;

FIG. 8 is a schematic flowchart of a K-means-clustering module, in accordance with some embodiments of the present disclosure;

FIGS. 9A-9F are examples of clustered output on graphs, in accordance with some embodiments of the present disclosure;

FIG. 10 is an example of a User Interface (UI), in accordance with some embodiments of the present disclosure;

FIG. 11. is an example of a User Interface (UI) to enter one or more criteria, in accordance with some embodiments of the present disclosure:

FIG. 12 is an example of a visual analysis of alert clusters, in accordance with some embodiments of the present disclosure; and

FIG. 13 is an example of details of the alerts to which priority is assigned, in accordance with some embodiments of the present disclosure.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements. units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

In current trade surveillance systems, there are rules to identify suspicious activities and forward alerts to users or operate other actions. However, occasionally there are company related events which may influence the volume of the trade of stocks, bonds, derivatives contracts, such as options, futures, and swaps, and other financial instruments, which are related to these companies.

For example, a company, such as Tesla® may publish positive news about acquiring Twitter. This type of news may cause a rise in trading volume of financial instruments related to both Twitter® and Tesla®. The increased volume of trade may create suspicious activities, such as large order entry, excessive cancels, and the like. As a result, a compliance officer may receive a large number of alerts of financial suspicious activity for inspection, which are directly related to the published news.

Utilizing News based data as an input to correlate alerts can add value by prioritizing issues related to current events and uncovering faster market abuse or insider dealing-related issues that the firm may be subject to. Oftentimes, financial services organizations may be involved in corporate events that are not yet public knowledge, thus, when giving compliance and control room team the ability to reference related alerts to the news once it has become public would ensure that the firm can recognize if there is any risk to the organization from individuals that may have taken advantage of such inside knowledge prior to the news event. It may also protect the firm from potential costly regulatory fines and reputational damage. Current technical solutions do not expose the full list of available news as a means for compliance officers to base their investigation of alerts related to suspicious activity.

Therefore, there is a need for a technical solution to link between this type of news and alerts in a trade surveillance system to prevent an overflow of false-positive alerts and to automatically act upon transactions and also as to an accumulated number of alerts relates to same account or trader.

There is a need for method and system for reducing false-positive transaction-alerts in a trade-surveillance system.

The term “data point”, as used herein, refers to financial transactions or to any activity related to a financial instrument.

The term “news”, as used herein, refers to information related to market which can impact market in positive or negative sense.

The term “trading volume”, as used herein, refers to the number of shares traded during a particular time period.

The term “symbol” as used herein, refers to a stock symbol is an arrangement of character usually letters representing publicly-traded securities on an exchange.

The term “alert” or “transaction-alert”, as used herein, refers to a message sent to a user upon detection of financial activity, e.g., transaction that is suspicious for fraud or any other non-legitimate activity, for further investigation by a user or for an automatic action, such as pausing the transaction or blocking the related account.

The term “Market Identified Code (MIC)”, as used herein, refers to stock markets and other exchanges in which securities are traded. The code is unique and includes four characters, starting with a randomly-assigned alphanumeric character, followed by a three-digit code to signify the market, such as “XNAS” for the Nasdaq market.

The term “source”, as used herein, refers to a platform origin from where news has arrived.

The term “relevance”, as used herein, refers to a number from 0 to 100 which signifies how relevant news is i.e., 0 for least relevant and 100 for most relevant.

The term “novelty”, as used herein, refers to a number from 0 to 100 which signifies the extent to which the news event is novel or an update of a news release.

The term “Identification Numbering system (ISIN)”, as used herein, refers to a standard for the unique identification of financial and referential instruments, including equity, debt, derivatives. and indices.

The term “centroid”, as used herein, refers to a data point that represents the center of the cluster i.e., the mean. In K-means, each cluster is represented by its center which is called a “centroid”, which corresponds to the arithmetic mean of data points assigned to the cluster.

The term “Euclidian distance”, as used herein refers to a distance between two points in Euclidean space which is the length of a line segment between the two points. It can be calculated from the Cartesian coordinates of the points using the Pythagorean theorem, therefore occasionally being called the Pythagorean distance.

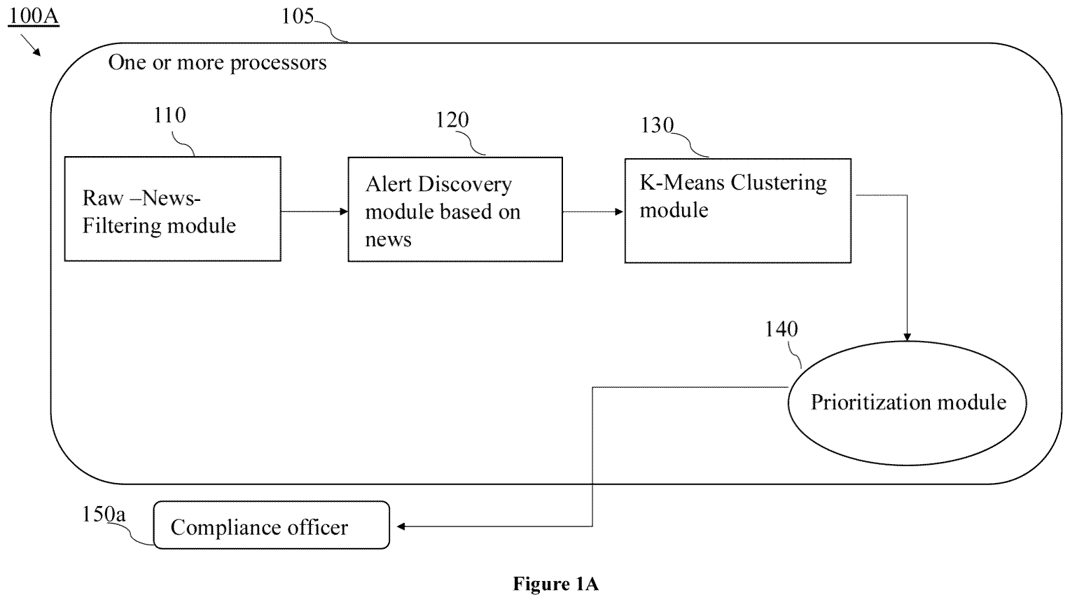

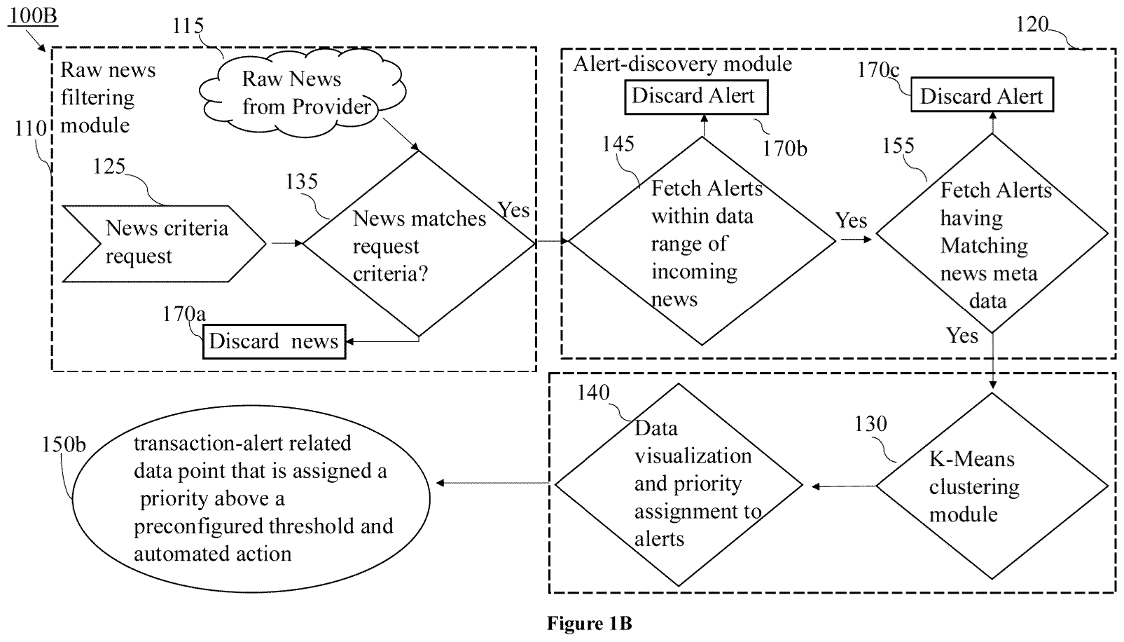

FIG. 1A schematically illustrates a high-level diagram of a computerized-system 100A for reducing false-positive transaction-alerts in a trade-surveillance system, in accordance with some embodiments of the present invention.

According to some embodiments of the present disclosure, in a system, such as computerized-system 100A, one or more processors 105 may be configured to operate a module, such as raw-news-filtering module 110 to select raw input stock-news, which are received from a platform of a source. based on preconfigured one or more criteria, to yield filtered stock-news. The source may be a platform of a news provider, such as Reuters, Dow Jones, Bloomberg, and Pearson.

According to some embodiments of the present disclosure, the preconfigured one or more criteria may be selected in real-time. Furthermore, the preconfigured one or more criteria may be implemented by a JavaScript Object Notation (JSON) object to store information of news criteria, such as company. NIP, relevance, category, ISIN, Market Identified Code (MIC), symbol and source.

According to some embodiments of the present disclosure, the raw input stock-news may include one or more events which are related to stock market and each event in the one or more events bas associated news-metadata.

According to some embodiments of the present disclosure, the associated news-metadata may include at least one of: (i) stock symbol: (ii) Market Identifier Code (MIC); and (iii) company information. The associated news-metadata may be implemented as an object to store information related to news metadata, such as news feed ID, company, News Impact Projection (NIP) score, relevance, category, news feed date, Identification Numbering system (ISIN), Market Identified Code (MIC), symbol, instrument ID, source, news title, news URL. The NIP score may range between 0 to 100 and may represent the degree of impact a news flash will have on the market in the following specified time period, e.g., 2 hour.

According to some embodiments of the present disclosure, transaction-alerts may be generated by analytics modules which comprise a set of detection algorithms. The transaction-alerts may be implemented as an object including information related to the transaction-alerts, such as alert ID, status, account, symbol, severity, instrument ID, ISIN, alert type, trader ID and timestamp.

According to some embodiments of the present disclosure, the one or more processors 105 may be configured to operate a module, such as alert-discovery module 120 to evaluate transaction-alerts, which are received in a preconfigured date-range. The evaluation may be based on the filtered stock-news, and the evaluation may yield one or more transaction-alert related data points.

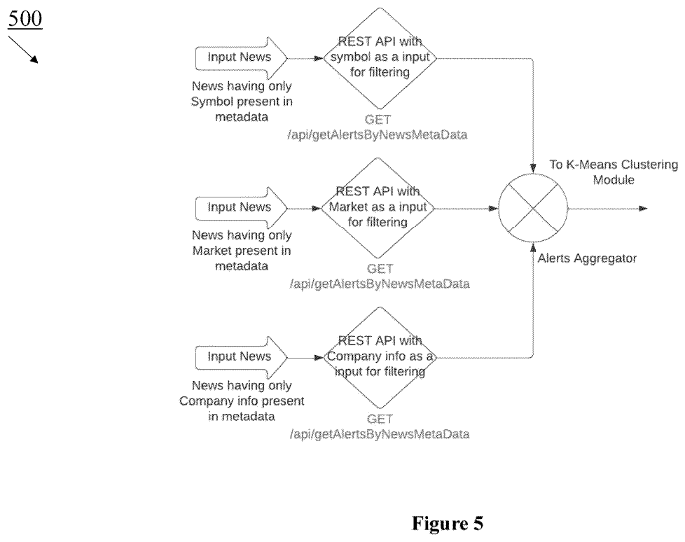

According to some embodiments of the present disclosure, the alert-discovery module 120 may evaluate the transaction-alerts by operating a set of Application Programming Interfaces (API)s which may fetch the transaction-alerts that have matching news metadata as in the filtered stock-news, from a database. For example, as shown in FIG. 5.

According to some embodiments of the present disclosure, the one or more processors 105 may be configured to operate a module. such as K-means-clustering module 130 to collect the transaction-alert related data points and form one or more clusters of the transaction-alert related data points. Each cluster of the one or more clusters may be associated with a category. The category may be selected from “low”, “medium”. “high”, or any another category.

The K-means-clustering module 130 may be implemented as a Machine Learning (ML) module. Furthermore, the K-means-clustering module 130 may use a dataset object to store the information and methods for the required calculations.

According to some embodiments of the present disclosure, the K-means-clustering module 130 may be operated by using a regular expressions language to match transaction-alerts and news-metadata of the one or more events to assign transaction-alert data points to a cluster. The regular expressions language is compatible with various programming languages like Java, and Python.

According to some embodiments of the present disclosure, the K-means-clustering module 130 may operate the assigning of each transaction-alert data point to a cluster by finding centroid assignment. The finding of the centroid assignment may be operated by calculating Euclidean distance. The Euclidean distance may be calculated by formula I:

$$d ( p , q ) = \sqrt{{\sum }_{i = 1}^{n} {( {q}_{i} - {p}_{i} )}^{2}} \qquad ( I )$$

whereby:
p,q are two random data points in an Euclidean n-space,
qᵢ, pᵢ are Euclidean vectors, starting from an origin of the space, and
n=n-space.

According to some embodiments of the present disclosure, the one or more processors 105 may be configured to operate a module, such as prioritization module 140 to assign a priority to each transaction-alert related data point of the transaction-alert related data points, based on the associated category of the cluster of the transaction-alert related data point and a transaction-related risk. The transaction-related risk may be calculated for each transaction, i.e., data point, by one or more algorithms.

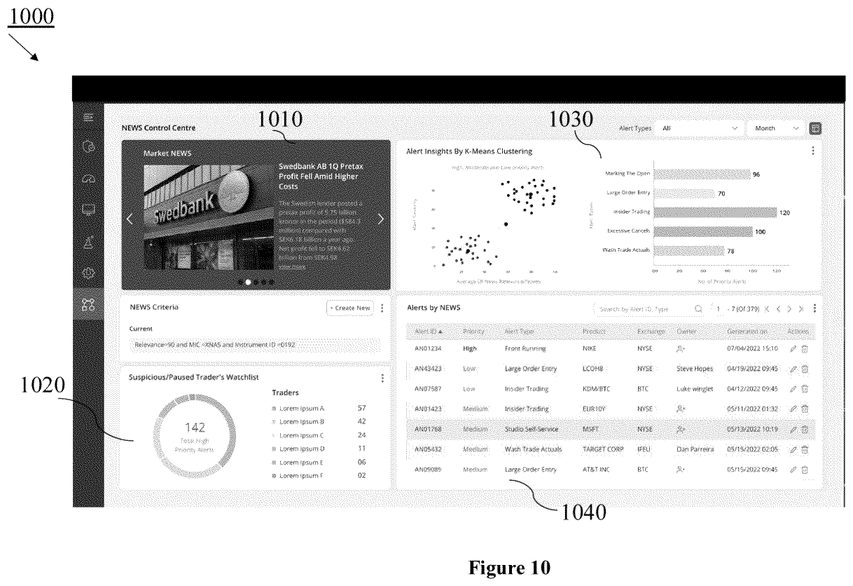

According to some embodiments of the present disclosure, the one or more processors 105 may be configured to forward each transaction-alert related data point, that is assigned a priority above a preconfigured threshold to a compliance officer 150 for further investigation. Furthermore, each transaction-alert related data point, that is assigned the priority above the preconfigured threshold, may be presented via a display unit with related details, as shown for example, in FIG. 10.

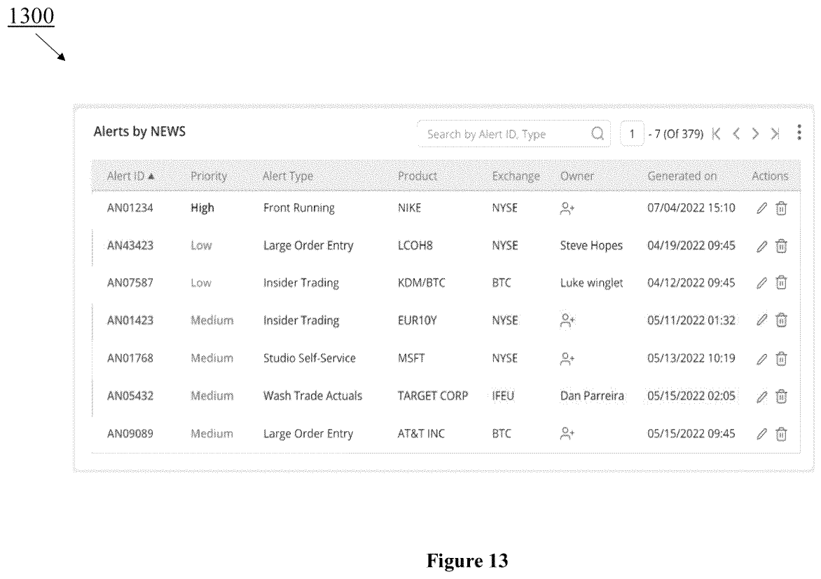

According to some embodiments of the present disclosure, optionally, each transaction-alert related data point that is assigned a priority above a preconfigured threshold, may be forwarded to a compliance officer 150a and may be presented with related details, for example as shown in FIG. 13.

According to some embodiments of the present disclosure, optionally, for each transaction-alert related data point, that is assigned the priority above the preconfigured threshold, the system 100A may be configured to pause a transaction that the transaction-alert related data point that is assigned the priority above the preconfigured threshold is related to.

According to some embodiments of the present disclosure, optionally, for each transaction-alert related data point that is assigned the priority above the preconfigured threshold, system 100A may put under a watchlist at least one of: (i) financial institution; (ii) trader; (iii) account, that a transaction that is related to the transaction-alert related data point that is assigned the priority above the preconfigured threshold has been conducted through.

According to some embodiments of the present disclosure, for each transaction-alert related data point that is assigned the priority above the preconfigured threshold, system 100A may be configured to pause the related transaction.

FIG. 1B schematically illustrates a high-level diagram of a computerized-system 100B for reducing false-positive transaction-alerts in a trade-surveillance system, in accordance with some embodiments of the present invention.

According to some embodiments of the present disclosure, a module, such as raw news filtering module 110 may receive raw news 115 from a provider or a source, such as a third-party news provider, e.g., Reuters, RavenPack and the like, to select raw input stock-news based on news criteria request 125, e.g., based on preconfigured one or more criteria to yield filtered stock-news. The one or more criteria may be selected from at least one of: (i) symbol; (ii) market; (iii) source; (iv) relevance-score; and (v) novelty.

According to some embodiments of the present disclosure, the raw news filtering module 110 may evaluate the received raw news 115 against the request parameters to yield a filtered stream of news, e.g., stock-news. The filtered stream of news if it matches request criteria 135 may be forwarded to an alert-discovery module 120 for evaluation of transaction-alerts thereon. News which does not match request criteria are discarded 170a.

According to some embodiments of the present disclosure, a module, such as alert-discovery module 120 may fetch transaction-alerts within a preconfigured data range of the incoming news 145, i.e., the filtered stream of stock-news. Transaction-alerts not within the data range may be discarded, e.g., discard alert 170b. The fetched transaction-alerts within a preconfigured data range may be further tuned on the news metadata. The alert-discovery module 120 may fetch alerts having matching news metadata 155. This news and alerts data may be handled by a map data structure having key and value, where news may be a key and a list of alerts may be a value.

According to some embodiments of the present disclosure, the map of news and alerts may be fed to a clustered Machine Learning (ML) module, such as K-means clustering module 130, where data points may be assigned to one of the clusters e.g., “high”, “medium”, and “low”. These priority alerts may be available to end users to reduce the time taken for investigation by initially considering transaction-alerts that has been assigned a certain priority. For example, assigned a priority above a preconfigured threshold.

According to some embodiments of the present disclosure, optionally, an automated action may be taken against the parties involved in the suspicious activities, such as notifying the respective bank or Asset Management Company (AMC) to pause trades and put them under a watchlist. A data visualization module 140 may plot these data points, e.g., transactions, to provide visual analysis to an end user.

According to some embodiments of the present disclosure, each transaction-alert related data point that is assigned a priority above a preconfigured threshold may be forwarded to a user as well as an automated action may be operated 150b.

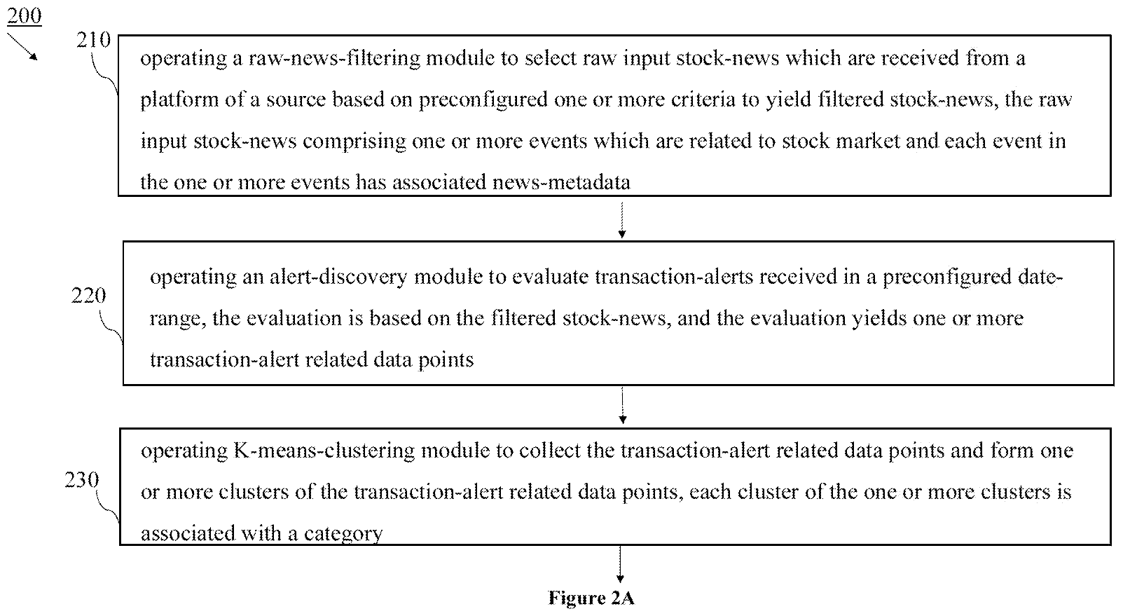

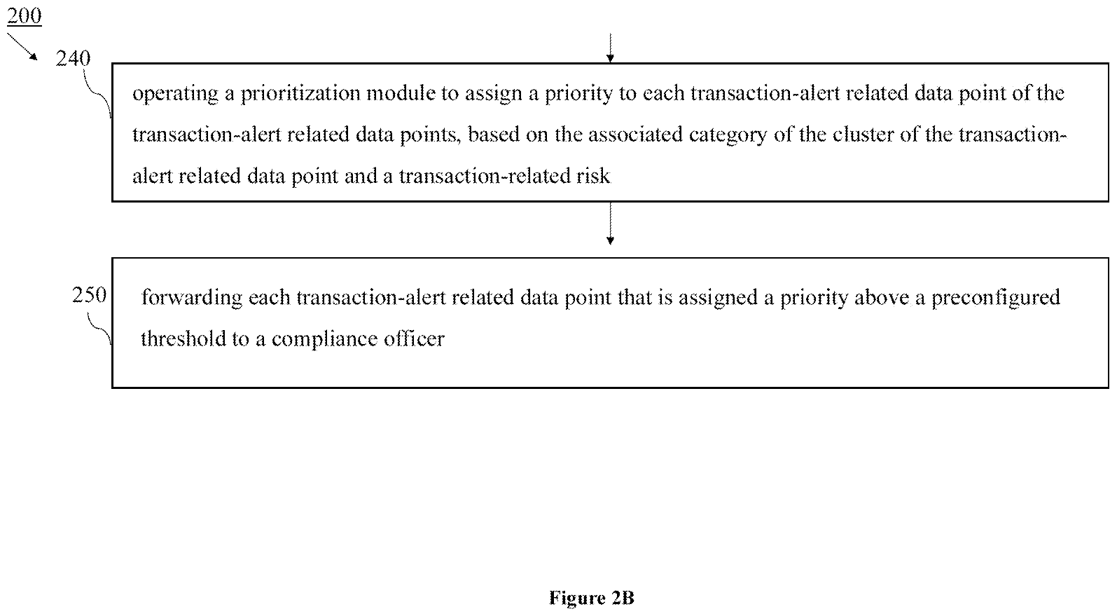

FIGS. 2A-2B are a schematic flowchart a computerized-method 200 for reducing false-positive transaction-alerts in a trade-surveillance system, in accordance with some embodiments of the present invention.

According to some embodiments of the present disclosure, operation 210 comprising operating a raw-news-filtering module to select raw input stock-news which are received from a platform of a source based on preconfigured one or more criteria to yield filtered stock-news, the raw input stock-news comprising one or more events which are related to stock market and each event in the one or more events has associated news-metadata.

According to some embodiments of the present disclosure, operation 220 comprising operating an alert-discovery module to evaluate transaction-alerts received in a preconfigured date-range, the evaluation is based on the filtered stock-news, and the evaluation yields one or more transaction-alert related data points.

According to some embodiments of the present disclosure, operation 230 comprising operating K-means-clustering module to collect the transaction-alert related data points and form one or more clusters of the transaction-alert related data points, each cluster of the one or more clusters is associated with a category.

According to some embodiments of the present disclosure, operation 240 comprising operating a prioritization module to assign a priority to each transaction-alert related data point of the transaction-alert related data points, based on the associated category of the cluster of the transaction-alert related data point and a transaction-related risk.

According to some embodiments of the present disclosure, operation 250 comprising forwarding each transaction-alert related data point that is assigned a priority above a preconfigured threshold to a compliance officer. The compliance officer may operate further investigation of the related transaction.

According to some embodiments of the present disclosure, optionally, each transaction-alert related data point that is assigned a priority above a preconfigured threshold may automatically pause the related transaction and add the related account or trader to a watchlist.

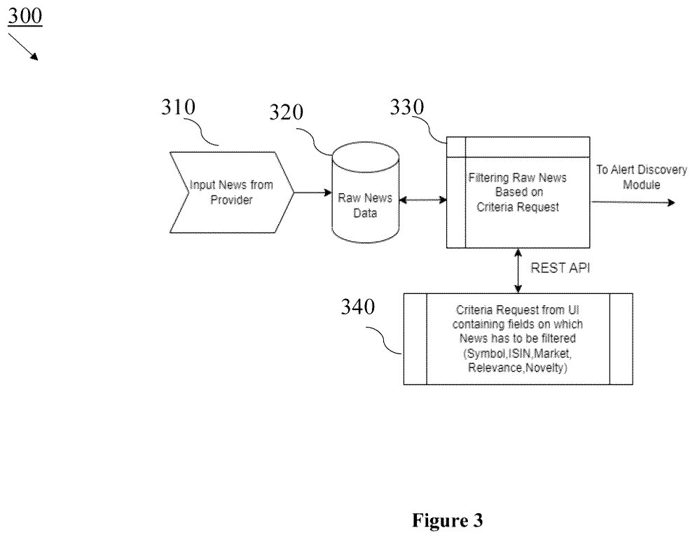

FIG. 3 is a schematic flowchart of a raw news filtering module 300, in accordance with some embodiments of the present invention.

According to some embodiments of the present disclosure, a module, such as raw news filtering module 300 and such as Raw-News-Filtering module 110 in FIGS. 1A-1B, may be operated in a computerized-system, such as system 100A to select raw input stock-news which are received from a platform of a source based on preconfigured one or more criteria to yield filtered stock-news.

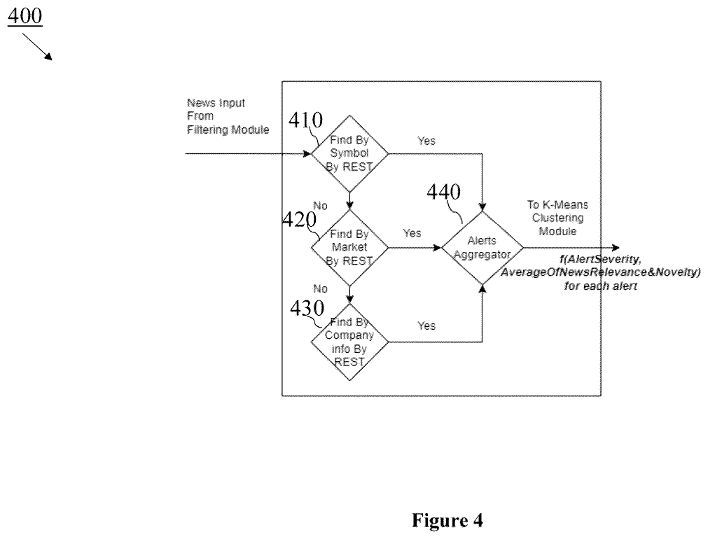

According to some embodiments of the present disclosure, raw news received from a source 310 may be stored in a database, such as raw news data 320 from where an API may fetch data, as shown for example, in FIG. 4. Raw news filtering module 300 may be filtering raw news based on criteria request 330 and then forwarded to a module, such as alert-discovery module 120 in FIG. 1A-1B to evaluate transaction-alerts received in a preconfigured date-range.

According to some embodiments of the present disclosure, the filtering raw news based on criteria request 330 may be based on preconfigured one or more criteria to yield filtered stock-news, e.g., criteria request from UI containing fields on which news has to be filtered, such as Symbol, ISIN, Market, Relevance, Novelty. The one or more criteria may be provided by Representational state transfer (REST) API request structure and the response may be forwarded to the alert-discovery module, such as alert-discovery module 120 in FIGS. 1A-1B and such as alert-discovery module 400 in FIG. 4.

According to some embodiments of the present disclosure, the raw input stock-news may include one or more events which are related to stock market and each event in the one or more events has associated news-metadata.

FIG. 4 is a schematic flowchart of an alert-discovery module 400, in accordance with some embodiments of the present invention.

According to some embodiments of the present disclosure, a module, such as alert-discovery module 400 may be operated in a computerized-system, such as system 100A in FIG. 1A to evaluate transaction-alerts received in a preconfigured date-range. The evaluation may be based on filtered stock-news, and it may yield one or more transaction-alert related data points.

According to some embodiments of the present disclosure, a response from the Representational State Transfer (REST) API consists of filtered news, e.g., filtered stock-news, may be used, e.g., as shown in FIG. 5, to select alerts in the alert-discovery module 400. The news-metadata of each event in the raw input stock-news may be used for finding alerts in the system. The news-metadata may include one or more criteria, such as symbol 410, market 420, source, relevance-score, novelty, and company 430.

According to some embodiments of the present disclosure, for example, GET REST API getAlertsByNewsMetaData( ) may be implemented to collect the transaction-alert related data points and form one or more clusters of the transaction-alert related data points. This REST API may use a regular expressions language to match transaction-alerts and news-metadata of the one or more events to assign transaction-alert data points to a cluster. Each cluster may indicate a category. The category may be selected from e.g., “Low”, “Medium”, “High”, or any other category.

According to some embodiments of the present disclosure, all the collected transaction-alert related data points may be aggregated by an alerts aggregator 440.

According to some embodiments of the present disclosure, the one or more transaction-alert related data points may be assigned a priority by a module, such as prioritization module. The priority may be assigned based on the associated category of the cluster of the transaction-alert related data point and a transaction-related risk.

According to some embodiments of the present disclosure, an analytical model is an analytical engine which is implemented by a set of algorithms which are used to operate trade surveillance and generate transaction-alerts. Optionally, the one or more transaction-alert related data points may be mapped as a function of alert severity which is a number between 0 to 100 to rate an alert in terms of severeness which is determined by the analytical model, which is responsible for alert generation, and it is unique for each type of alert, and an average of news relevance and novelty f(x,y)=f(AlertSeverity, AverageOfNewsRelevance&Novelty). The function may be used to plot the data points on two-dimensional plane before running a clustering algorithm, such as K-Means clustering module 130 in FIG. 1A.

FIG. 5 is a diagram 500 which illustrates a request for data using Application Programming Interface (API), in accordance with some embodiments of the present invention.

According to some embodiments of the present disclosure, based on the type of news-metadata that is available in news input, a call may be made to GET REST API getAlertsByNewsMetaData ( ) Symbol may be a preferred news-metadata as it provides an accurate mapping followed by market and company information.

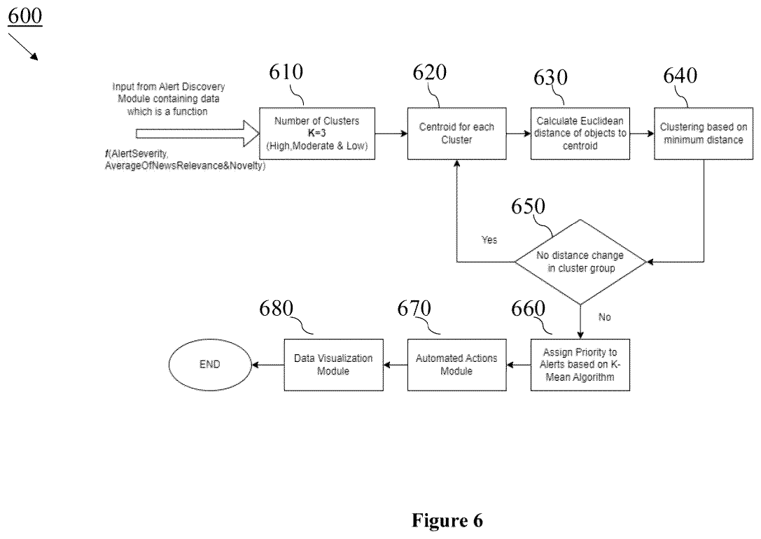

FIG. 6 is a schematic flowchart of a K-means-clustering module 600, in accordance with some embodiments of the present invention.

According to some embodiments of the present disclosure, K-means-clustering module, such as K-means-clustering module 130 in FIGS. 1A-1B may be operated to collect the transaction-alert related data points and form one or more clusters of the transaction-alert related data points, where each cluster of the one or more clusters is associated with a category.

According to some embodiments of the present disclosure, the K-Means clustering module 600 may be implemented as an unsupervised learning algorithm. There is no labeled data for the clustering, in contrast to a supervised learning approach. K-Means clustering module 600 may perform a division of objects, e.g., transaction-alert related data points into clusters that share similarities and are dissimilar to the objects belonging to another cluster.

According to some embodiments of the present disclosure, for example, when K=3 it indicates three categories of clusters, e.g., “high”, “medium”, and “low” clusters 610, the K-Means clustering module 600 may assign three centroids randomly 620. For every data point, in the transaction-alert related data points which were yielded by a module, such as the alert-discovery module 400 in FIG. 4, the K-Means clustering module 600 may search for a centroid that is nearest to it, by calculating Euclidean distance 630 by formula (I):

$$d ( p , q ) = \sqrt{{\sum }_{i = 1}^{n} {( {q}_{i} - {p}_{i} )}^{2}} \qquad ( I )$$

p,q=two points in Euclidean n-space,
q_i, p_i=Euclidean vectors, starting from the origin of the space (initial point), and
n=n-space.

According to some embodiments of the present disclosure, the K-Means clustering module 600 may assign the data point to the calculated nearest centroid. i.e., clustering based on minimum distance 640. For every centroid, the centroid may move to the average of the points assigned to that centroid. In every iteration withing the Machine Leaning (ML) model of the K-Means clustering module 600, the centroid may move and after n-iterations, the centroid may stop moving.

According to some embodiments of the present disclosure, the following operations may be repeated: 1. random centroid assignment; 2. calculating Euclidean distances of each data points from centroid; and 3. clustering based on minimum distance calculated. The K-Means clustering module 600 is said to have “converged” once there are no more changes 650.

According to some embodiments of the present disclosure, after the K-Means clustering module 600 has formed one or more clusters of the transaction-alert related data points. e.g., three clusters, when K=3 then priority may be assigned to alerts based on the K-Means algorithm 660.

According to some embodiments of the present disclosure, optionally, automated actions may be operated by an automated actions module 670 for transaction-alert related data points which were assigned a priority, based on the associated category of the cluster of the transaction-alert related data point and a transaction-related risk.

According to some embodiments of the present disclosure, for example, each transaction-alert related data point that is assigned a priority above a preconfigured threshold may be put under a watchlist related to a trader or an account and once the watchlist reaches a preconfigured count of transaction-alert related data points the trader or account may be blocked.

According to some embodiments of the present disclosure, in another example, if a particular trader has high-priority alerts e.g., transaction-alert related data points throughout a wide timespan, a notification may be sent to the respective bank or Asset Management Company (AMC) to pause the trader's transactions and put the trader or the account of the watchlist on hold until the investigation is complete.

According to some embodiments of the present disclosure, a data visualization module 980 may be operated to present the results of the transaction-alerts priority and other related details, as shown in example 1300 FIG. 13.

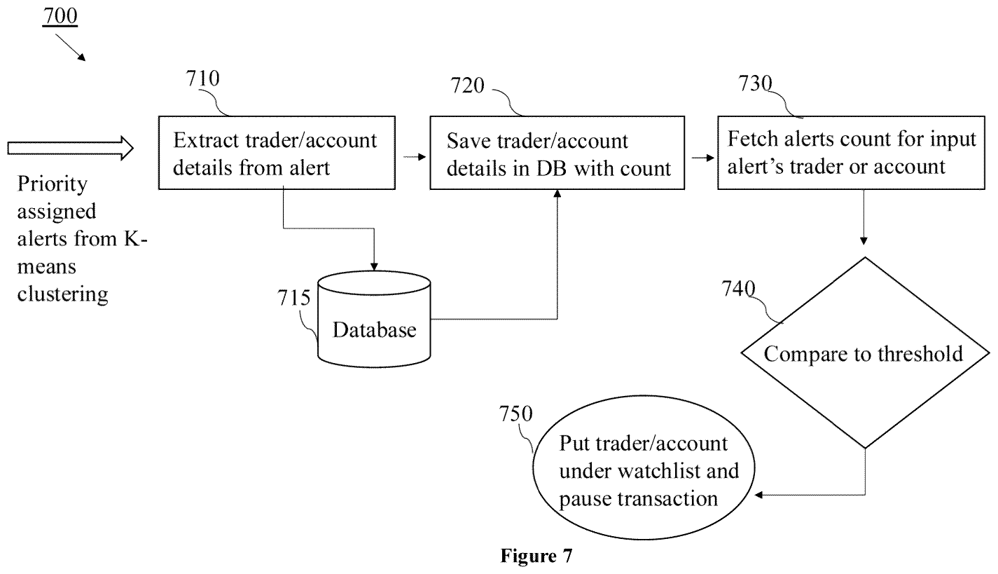

FIG. 7 a schematic flowchart of an example 700 of high-priority alerts assigned to an account or to a trader, in accordance with some embodiments of the present invention.

According to some embodiments of the present disclosure, a computerized-system, such as system 100A in FIG. 1A may further include a database, such as database 715 to store transaction-alert related data point that is assigned a priority above a preconfigured threshold. For each transaction-alert related data point that is assigned a priority above a preconfigured threshold trader or account details may be extracted from the transaction-alert 710.

According to some embodiments of the present disclosure, the extracted trader or account details may be saved in the database with count 720, which means that during a preconfigured period of time the number of transaction-alert related data points for each trader or account are counted.

According to some embodiments of the present disclosure, the alerts count for input alert's trader or account may be fetched 730 and may be compared to a threshold 740. When the alert's count is above the threshold the trader or account may be put under a watchlist and the transaction may be paused 750.

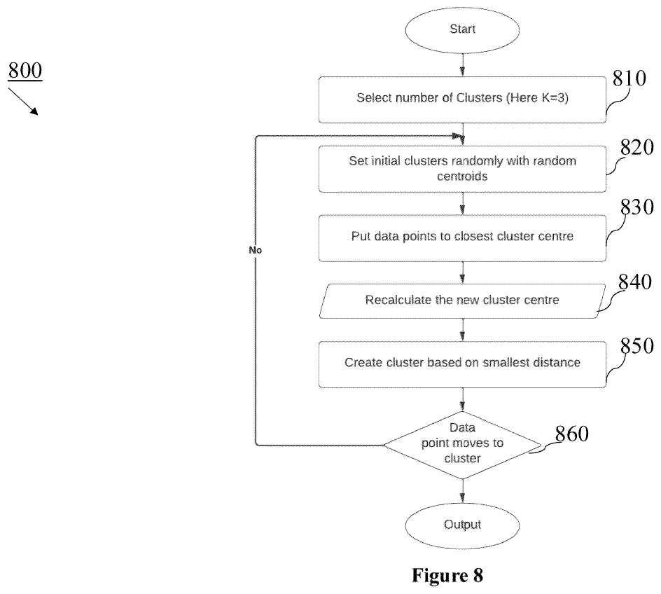

FIG. 8 is a schematic flowchart of a K-means-clustering module 800, in accordance with some embodiments of the present disclosure.

According to some embodiments of the present disclosure, a module, such as K-means-clustering module 800 and such as K-means clustering module 600 in FIG. 6 may select a number of cluster, for example three, i.e., K=3 810.

According to some embodiments of the present disclosure, the K-means-clustering module 800 may set initial clusters randomly with random centroids 820.

According to some embodiments of the present disclosure, the K-means-clustering module 800 may put data points to closest cluster center 830.

According to some embodiments of the present disclosure, the K-means-clustering module 800 may recalculate a new cluster center 840.

According to some embodiments of the present disclosure, the K-means-clustering module 800 may create cluster based on smallest distance 850 and then check if a data point moves to cluster 860. If the data point doesn't move to cluster repeating operations 820 through 860.

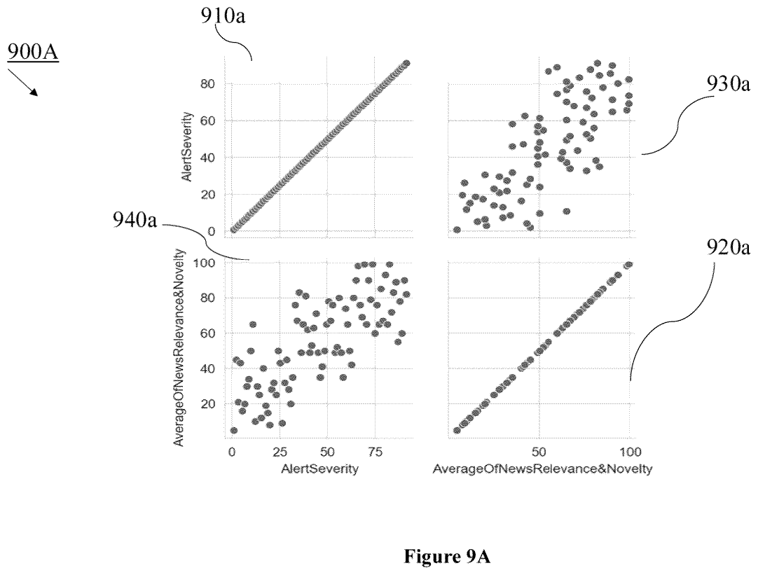

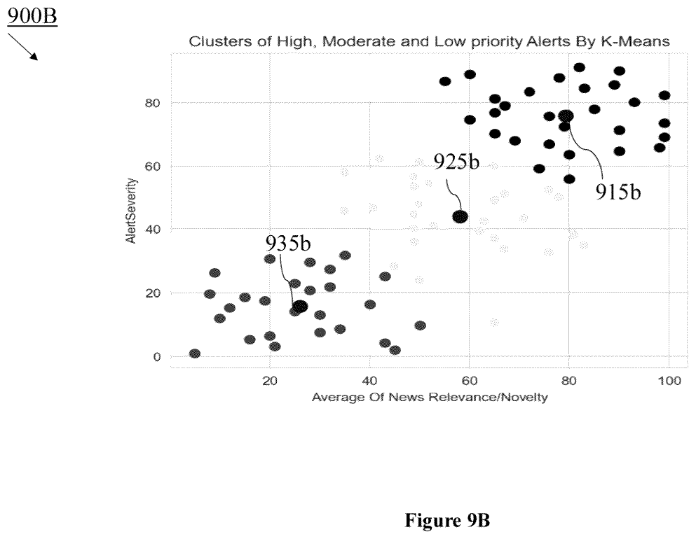

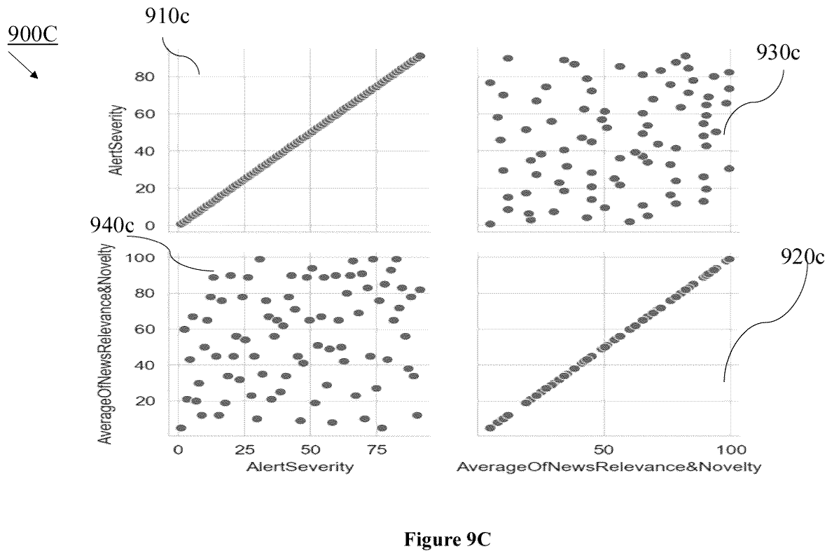

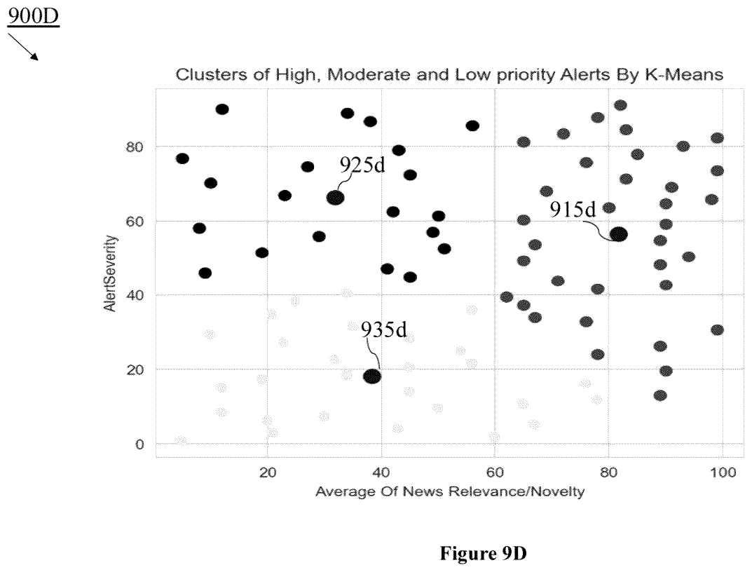

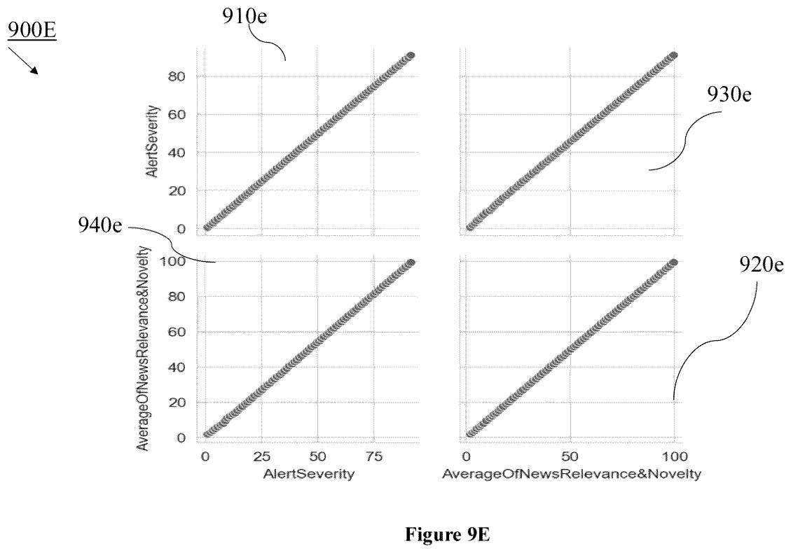

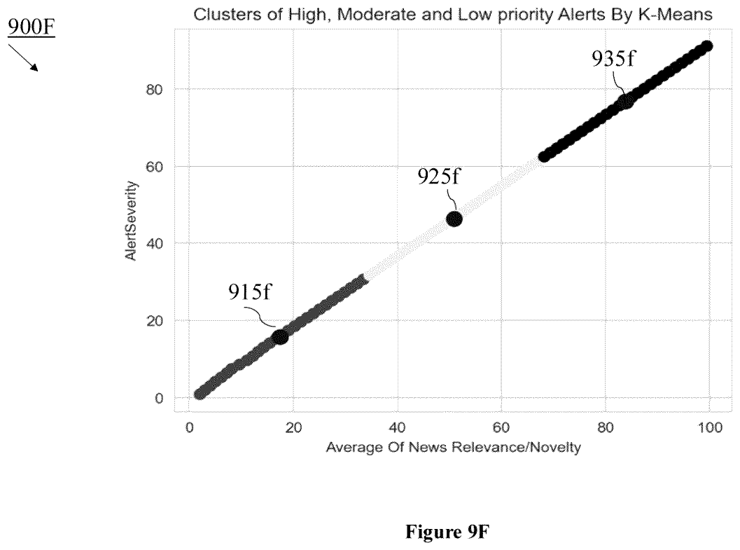

FIG. 9A is an example 900A of clustered output on graphs, in accordance with some embodiments of the present disclosure.

According to some embodiments of the present disclosure, graph 910a shows how data points of only alert severity would look like, in two-dimensional space, when its plotted on graph. Graph 920a shows how data points only of AverageOfNewsRelevance&Novelty would look like, in two-dimensional space, when plotted on graph. 930a graph shows how data points of alertSeverity are plotted on Y-axis and data points of AverageOfNewsRelevance&Novelty are on X-axis. 940a graph shows how graph will look like when data points of alertSeverity are plotted on X-axis and data points of AverageOfNewsRelevance&Novelty on Y-axis.

FIG. 9B is an example 900B of clustered output on graphs, in accordance with some embodiments of the present disclosure.

According to some embodiments of the present disclosure, when a module, such as K-means-clustering module 800 in FIG. 8 and such as K-means clustering module 600 in FIG. 6 has created three clusters e.g., as “Low”, “Medium” and “High” respectively the centroids of each cluster is designated by 915b, 925b and 935b.

FIG. 9C is an example 900C of clustered output on graphs, in accordance with some embodiments of the present disclosure.

According to some embodiments of the present disclosure, graph 910c shows how data points only of alert severity would look like if its plotted on graph. Graph 920c shows how data points only of AverageOfNewsRelevance&Novelty would look like if plotted on graph. Graph 930c shows how graph will look like when data points of alertSeverity are plotted on Y-axis and data points of AverageOfNewsRelevance&Novelty on X-axis. Graph 940c shows how graph will look like when data points of alertSeverity are plotted X-axis data points of AverageOfNewsRelevance&Novelty on Y-axis.

FIG. 9D is an example 900D of clustered output on graphs, in accordance with some embodiments of the present disclosure.

According to some embodiments of the present disclosure, clusterId may be assigned to the data points which are used to assign priority to alerts. A module, such as K-means-clustering module 800 in FIG. 8 and such as K-means clustering module 600 in FIG. 6 may create three clusters. e.g., “Low”, “Medium” and “High” respectively for any type of input data distribution, even when the data distribution is random in nature, the clustering algorithm may assign clusters to each data point irrespective of its type of distribution. The centroids of each cluster indicated is designated by 915d, 925d and 935d.

FIG. 9E is an example 900E of clustered output on graphs, in accordance with some embodiments of the present disclosure.

According to some embodiments of the present disclosure, graph 910e shows how data points only of alert severity would look like in tow-dimensional space, if its plotted on graph. Graph 920e shows how data points only of AverageOfNewsRelevance&Novelty would look like in tow-dimensional space if plotted on graph. Graph 930e shows how data points only of alertSeverity are plotted on Y-axis and data points of AverageOfNewsRelevance&Novelty on X-axis will look like in two-dimensional space. Graph 940e shows how data points only of alertSeverity are plotted on X-axis and data points only of AverageOfNewsRelevance&Novelty on Y-axis will look like in two-dimensional space.

FIG. 9F is an example 900F of clustered output on graphs, in accordance with some embodiments of the present disclosure.

According to some embodiments of the present disclosure, a module, such as K-means-clustering module 800 in FIG. 8 and such as K-means clustering module 600 in FIG. 6 has created three clusters as “Low”, “Medium’ and “High” respectively for any type of input data distribution even when the data distribution is linear in nature, the clustering algorithm may assign clusters to each data point irrespective of its type of distribution. The centroids of each cluster indicated is designated by 915f, 925f and 935f.

According to some embodiments of the present disclosure,

FIG. 10 is an example of a User Interface (UI) 1000, in accordance with some embodiments of the present disclosure.

According to some embodiments of the present disclosure, widget 1010 may present all the input news as per criteria given by a user, such as a compliance officer in the widget ‘News Criteria’. Widget 1010 may provide insights about the incoming news by market or any other criteria to help the user, such as compliance officer to better understand the data.

According to some embodiments of the present disclosure, widget 1030 may provide a visual output of a system, such as system 100A in FIG. 1A or system 100B in FIG. 1B, which includes a graph and a bar chart consisting of priority alerts count by type which may assist a compliance officer to predict market trends.

According to some embodiments of the present disclosure, widget 1040 may provide transaction-alert related data point and its related priority. The priority may be assigned to the alerts based on market news which may assist the compliance officers to investigate in a faster and more focused way.

According to some embodiments of the present disclosure, widget 1020 may display a watchlist of traders or accounts whose trades should be blocked. This information may be notified to Bank or AMC whose trades are being surveillianced.

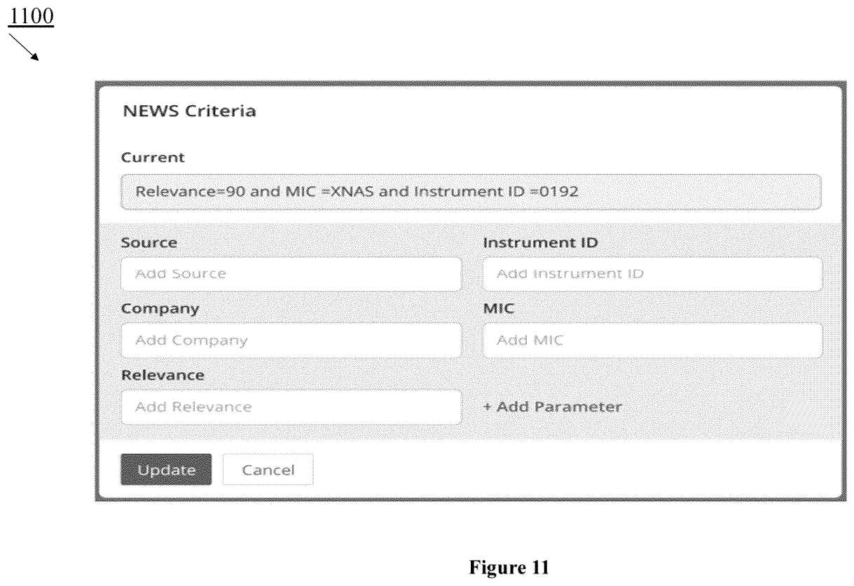

FIG. 11. is an example 1100 of a User Interface (UI) to enter one or more criteria, in accordance with some embodiments of the present disclosure.

According to some embodiments of the present disclosure, a news criteria section in UI 1000 in FIG. 10 may expand to show all fields which are eligible for request criteria. It may include fields such as Source, InstrumentID, Company. MIC, Relevance. The one or more criteria may be selected from symbol, market, source, relevance-score, and novelty.

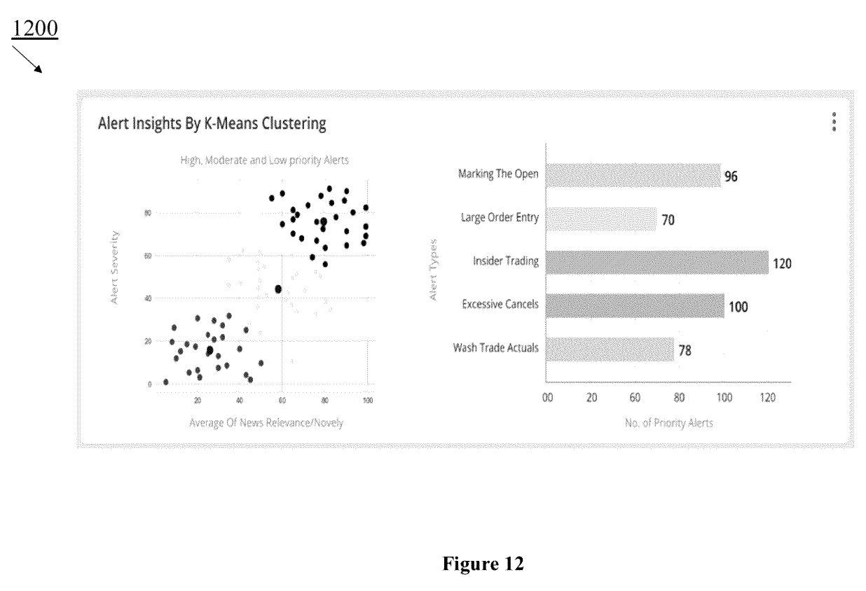

FIG. 12 is an example 1200 of a visual analysis of alert clusters, in accordance with some embodiments of the present disclosure.

According to some embodiments of the present disclosure, example 1200 is of a widget, such as widget 1030 in FIG. 10, which may provide a visual output of a system, such as system 100A in FIG. 1A or system 100B in FIG. 1B, which includes a graph and a bar chart consisting of priority alerts count by type which mat assist a compliance officer to predict market trends.

FIG. 13 is an example 1300 of details of the alerts to which priority is assigned, in accordance with some embodiments of the present disclosure.

According to some embodiments of the present disclosure, example 1300 is of a widget such as widget 1040 in FIG. 10, which may provide transaction-alert related data point and its related priority, as may be generated by system 100A in FIG. 1A or system 100B in FIG. 1B. The priority may be assigned to the alerts based on market news which may assist the compliance officers to investigate in a faster and more focused way.

According to some embodiments of the present disclosure, if a trader or account have found to have high priority alerts over wide timespan, solution pause trades of such parties until investigation gets complete. In the widget columns details of the alerts to which priority is assigned. An alert may be assigned for investigation for another compliance officer, e.g., owner.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. A computerized-method for reducing false-positive transaction-alerts in a trade-surveillance system, said computerized-method comprising:
operating a raw-news-filtering module to select raw input stock-news which are received from a platform of a source based on preconfigured one or more criteria to yield filtered stock-news, wherein the raw input stock-news comprising one or more events which are related to stock market and wherein each event in the one or more events has associated news-metadata:
operating an alert-discovery module to evaluate transaction-alerts received in a preconfigured date-range,
wherein the evaluation is based on the filtered stock-news, and
wherein the evaluation yields one or more transaction-alert related data points;
operating K-means-clustering module to collect the transaction-alert related data points and form one or more clusters of the transaction-alert related data points, wherein each cluster of the one or more clusters is associated with a category;
operating a prioritization module to assign a priority to each transaction-alert related data point of the transaction-alert related data points, based on the associated category of the cluster of the transaction-alert related data point and a transaction-related risk; and
forwarding each transaction-alert related data point that is assigned a priority above a preconfigured threshold-to a compliance officer.

2. The computerized-method of claim 1, wherein the one or more criteria are selected from at least one of: (i) symbol; (ii) market; (iii) source; (iv) relevance-score; and (v) novelty.

3. The computerized-method of claim 1, wherein the platform of source is a platform of a news provider.

4. The computerized-method of claim 1, wherein said news-metadata comprising at least one of: (i) stock symbol; (ii) Market Identifier Code (MIC); (iii) company information.

5. The computerized-method of claim 1, wherein said K-means-clustering module is operated by using a regular expressions language to match transaction-alerts and news-metadata of the one or more events to assign transaction-alert data points to a cluster.

6. The computerized-method of claim 5, wherein the assigning of each transaction-alert data point to a cluster is by finding centroid assignment.

7. The computerized method of claim 6, wherein the finding of the centroid assignment is by calculating Euclidean distance, said Euclidean distance is calculated by formula I:
$$d ( p , q ) = \sqrt{{\sum }_{i = 1}^{n} {( {q}_{i} - {p}_{i} )}^{2}}$$
whereby:
p,q are two random data points in an Euclidean n-space,
q_i, p_i are Euclidean vectors, starting from an origin of the space, and
n=n-space.

8. The computerized-method of claim 1, wherein the preconfigured one or more criteria are selected in real-time.

9. The computerized-method of claim 1, wherein the category is selected from at least one of: (i) low; (ii) medium; (iii) high; and (iv) another category.

10. The computerized-method of claim 1, wherein a notification is sent as to each transaction-alert related data point that is assigned a priority above the preconfigured threshold to a compliance officer for investigation.

11. The computerized-method of claim 1, wherein for each transaction-alert related data point that is assigned the priority above the preconfigured threshold, the computerized-method is further comprising pausing a transaction that the transaction-alert related data point that is assigned the priority above the preconfigured threshold related to.

12. The computerized-method of claim 1, wherein for each transaction-alert related data point that is assigned the priority above the preconfigured threshold putting at least one of: (i) financial institution; (ii) trader; (iii) account, that a transaction that is related to the transaction-alert related data point that is assigned the priority above the preconfigured threshold has been conducted through, under a watchlist.

13. The computerized-method of claim 1, wherein each transaction-alert related data point that is assigned the priority above the preconfigured threshold is presented via a display unit with related details.

14. The computerized-method of claim 1, wherein the transaction-alerts are generated by analytics modules which comprise a set of detection algorithms.

15. The computerized-method of claim 1, wherein the alert-discovery module is evaluating the transaction-alerts by operating a set of Application Programming Interfaces (API) s which fetch the transaction-alerts that have matching news metadata as in the filtered stock-news, from a database.

16. A computerized-system for reducing false-positive transaction alerts in a trade-surveillance system, said computerized-system comprising:
one or more processors, said one or more processors are configured to:
operate a raw-news-filtering module to select raw input stock-news which are received from a platform of a source based on preconfigured one or more criteria to yield filtered stock-news, wherein the raw input stock-news comprising one or more events which are related to stock market and wherein each event in the one or more events has associated news-metadata;
operate an alert-discovery module to evaluate transaction-alerts received in a preconfigured date-range,
wherein the evaluation is based on the filtered stock-news, and
wherein the evaluation yields one or more transaction-alert related data points
operate K-means-clustering module to collect the transaction-alert related data points and for one or more clusters of the transaction-alert related data points, wherein each cluster of the one or more clusters is associated with a category,
operate a prioritization module to assign a priority to each transaction-alert related data point of the transaction-alert related data points, based on the associated category of the cluster of the transaction-alert related data point and a transaction-related risk; and
forward each transaction-alert related data point that is assigned a priority above a preconfigured threshold-to a compliance officer.
